(19) United States
(12) Patent Application Publication
(10) Pub. No.: US 2002/0138166 A1
(43) Pub. Date: Sep. 26, 2002

(54) Data processing system for implementing an exchange

(75) Inventors: Steven Siong Cheak Mok, Singapore (SG); Yew Hing Chong, Singapore (SG); Soon Teong Poh, Singapore (SG)

Correspondence Address: IPSOLON LLP, 805 SW BROADWAY, #2740, PORTLAND, OR, 97205, US

(73) Assignee: Milling Systems & Concepts Pte Ltd

(21) Appl. No.: 09/966,906

(22) Filed: Sep. 27, 2001

Related U.S. Application Data
(60) Provisional application No. 60/277,741, filed on Mar. 21, 2001.

(51) Int. Cl. G06F 19/00

(52) U.S. Cl. 700/96; 700/97; 700/99; 700/104

(57) ABSTRACT

A web-based data processing system is used in a Business-to-Business (B2B) exchange for providing one-stop manufacturing solutions. In a B2B exchange, this system provides a moderator desktop for project planning, quoting, coordination and supervisory of all web-based business transactions from mechanical/electronic design and production of first article, tooling, production, financing, insurance, warehousing to end-product delivery. Also, this system provides a machine web communication desktop for web-based maintenance and support to members, process lines, systems and machines, and web-based resource sharing to “pay as you go” members and “flat fee” members. Likewise, this system provides dedicated desktops for other participants in the B2B exchange for direct and critical communication, collaboration and commerce transaction with moderator and machine web communication center. Said participants include Customers, Process lines/systems/machines, Strategic Partners, Suppliers and Management team/account/audit/administrator. This system also distributes and manages Request for Quotations (RFQs) for said B2B exchange in NAFTA, Asia Pacific and Europe data servers. Besides, the web-based data processing system provides a direct communication with a collaborative platform. Said collaborative platform may be integrated with existing web-based Enterprise Resource Planning (ERP) and Supply Chain Management (SCM).

This Invention relates to a data processing system for implementing an exchange between an entity specifying a manufacturing task that is to be completed, and a plurality of manufacturing facilities which may be capable of carrying out the manufacturing task.

### BACKGROUND

HAHT (www.haht.com) categorizes Business-to-business (B2B) exchanges into four different business relationship systems, such as private extranets, private exchanges, public exchanges and consortium-based exchanges.

Private extranets provides a data processing system (May not be web-based) for the most trusted supplier/customer partnerships. Such system is developed to Improve the efficiency and communication in partners' most strategic B2B processes. Since participation in a private extranet is very small, the partners can invest In specialized technology to optimize the flow of information, transactions, products and services between one another. (One-to-one or One-to-few model, e.g. typical extranets between established companies and their in-house venders)

Private exchanges provides a web-based data processing system, wherein suppliers use this system embedded in their e-commerce website to create a market for their products, providing buying and servicing experience for existing customers, and also to engage new customers. On the other hand, buyers use said system to engage and compare suppliers, and thereby to optimize their buying resources. (One-to-many model: e.g. Internet banking portals, Internet brokerages and regional dealers e-commerce websites)

Public exchanges, that are also called horizontal exchanger provide a web-based data processing system for commerce for virtually any kind of participant, product or service. Said system allows excess inventory sales, focuses on a particular buying and selling community, focuses an a particular set of products, or simply provides open auction electronic mechanism. (Many-to-many model: e.g. On-line classified, On-line auction and On-line cataloging)

Consortium-based exchanges provide a tightly couple web-based data processing system to vertical Industries. Such exchanges are motivated by the leading buyers in the market, but usually supported by suppliers, offers ideally a win-win scenario for all concerned. The terms, conditions, transaction definitions, and other elements of commerce in a vertical exchange are turned to reflect the particular practices of the vertical. Most participants benefit from the resulting increase in market efficiency. (Some-to-some model: e.g. automotives portal, petrol-chemical portal, medical portal and healthcare portal.)

Consortium-based exchanges start taking their unique/novel approaches to bringing together buyers and sellers of “custom” and “made to order parts.” When companies like Ford, General Motor and General Electric attempt to condense and streamline their laborious supply chain. Additionally, many large companies are using on-line auctions to grind down supplier's prices.

Existing consortium-based B2B exchanges believe that companies like Ford and Firestone will have to focus on quality, responsiveness, and delivery to meet the demands of the future. There's more to consider than just price. Internet auction models may work for basic commodities but they are not a long-term answer for responsible businesses.

These B2B exchanges claim to be a global member network that brings companies together based on their unique manufacturing “processes” rather than simple products, catalogs, and keyword search. With such exchanges, a member company can find pre-qualified business partners globally, with one simple click.

A typical manufacturing B2B exchange has the following web-based data processing system. When a company decides to join the exchange, they log on to the web site and fill out a comprehensive (tedious) questionnaire. The Information includes details about the company, their engineering and process capabilities, manufacturing methods, materials used, quality certifications, and even includes links to the member company's web site. This Information is next verified by the staffs of the exchange or worldwide affiliated representatives and then documented into a data server. Subsequently, a web-based data processing system creates a community identifier for the particular company similar to a fingerprint or a company's DNA. During a RFO transection, said system automatically matches a list of potential sellers of “custom” and “made to order parts” to the buyers.

Generally, the added value of a manufacturing web-based data processing system comes from accurate access to companies that provide tooling, molds, dies, castings, grinding, heat-treating, extrusions & metal forming processes. Such system may help to efficiently establish the buyers' connections or links with manufacturers and vendors of materials, machine tools, equipment, packaging, shipping and import/export financing.

Problem Statement

In a general RFO transaction, buyers rate sellers on: Price, Quality, Delivery and Responsiveness. At the same time, sellers rate buyers on: Payment and Responsiveness. A B2B exchange usually positions herself as a neutral party, who may provide a sophisticated rating system. Theoretically, an ideal B2B exchange should be able to guarantee the buyers the quality of the suppliers while assuring tho suppliers a series of businesses from the buyers.

Unfortunately, in practical,

1. A conventional B2B exchange fails to be a neutral party between buyers and suppliers because, in most conventional B2B exchanges, the supplier contributes a major portion of the income in B2B exchange. Therefore, a buyer interest will not 100% been protected, especially if a conflict happens between the buyer and the supplier.

2. The conventional B2B exchange fails to be a neutral party among suppliers because small or medium manufacturers always have lower qualification and/or could not afford to offer price as low as any established suppliers. (From the conventional B2B exchange, a small or medium company can purely gain some RFQ bidding experiences.)

3. Buyers demand for the quality of end products, instead of a compilation of certified suppliers by the exchange's wed-based data processing system. For instance, a certified supplier may have supplied a lower grade or expired material due to the inexpensive quote he has committed. Therefore, buyers ultimately bear their own risks of confirming the order. (A zealous company many hit the lowest price, at the last second, by committing to a long-term contract with one simple click.)

4. Conventional web-based data processing system faces difficulties in verifying the suppliers. A main certified supplier might obtain resources from several small suppliers. These small suppliers might come from different countries with different qualifications. In a worst-case scenario, the main supplier might act as a middleman (“loan” their brand names to small suppliers) In a RFQ process. Consequently, buyer in the B2B exchange will obtain a “reasonable” and “mark-up” quote.

### SUMMARY OF THE PRESENT INVENTION

To solve the problems described above, a web-based data processing system is proposed. This system is able to upgrade a conventional B2B exchange to a total integrated electronic business for one-stop manufacturing solution.

“Total integrated electronic business” in the context can be described as a business community, which consists of a comprehensive global network of certified suppliers and strategic partners. This global business community invests in a web-based collaborative platform to optimize the flow of information, transactions, products and services between one another. This global business community shall offer all buyers, suppliers and strategic partners synchronized business objective, a standard pricing system, single collaborative platform, an international procurement center, centralized resources (e.g. remote software) and supplier-to-supplier support (e.g. retrofitting supplier provides service to Diecasting solution provider within the B2B exchange).

Likewise, “onestop manufacturing solution” in this context covers a whole spectrum of manufacturing business and supply chain management, which may be demanded by any B2B customer. This spectrum covers from mechanical/electronic design, production & turnkey services, software & hardware customizations, trading of industrial products, remote software services, resource sharing, maintenance & support, insurance, financing/hire purchase leasing to end-product delivery. Also, said customer does not limited to solution buyers, end-users, licensees, “pay as you go” member, “flat fee” member, web-based process-lines, systems and machines.

The web-based data processing system provides (1) a moderator desktop and (2) a machine web communication desktop.

The Moderator desktop provides staffs in an exchange a set of tools for planning, quoting, coordination and supervisory on all web-based business transactions for solution buyers, end-users and licensees.

This staff or “moderator” represents customer, in which said customers need not be technical persons who EXACTLY understand process of making products. Also, meditator is the MOST SUITABLE candidate to execute a project or job with respect to customer's targeted budget and tight delivery schedule because he is familiar with competencies of suppliers from Asia-Pacific, Europe and NAFTA hubs and real-time accesses the suppliers' plant capacities. He is the chief project coordinator to acknowledge necessary arrangements of spare part procurement, warehousing, financing, insurance as well as end-product delivery services through a moderator desktop.

Such desktop protects 100% customers' interests in accordance to the responsiveness of RFQ and/or project status, product/solution quality, project cost, and delivery schedule.

Machine web communication desktop is to provide web-based maintenance and support to members, process lines, systems and machines, and web-based resource sharing to “pay as you go” members and “flat fee” members.

Web-based maintenance and support includes:

emergency support,

critical service support,

routine technical support,

online training,

critical spare parts order,

software and control upgrades, and

repair and test services.

Web-based resource sharing includes:

collaborative platform integrated with web-based Enterprise Resource Planning (ERP) and Supply Chain Management (SCM).

personnel/experts; Center for Advanced Numerical Engineering and Simulation and International Procurement Center,

Hardware/Equipment: Research and Testing Center;

Software: Remote Computer-Aided Design (CAD), Remote Computer-aided Engineering (CAE) and Remote Camputer-Aided Manufacturing (CAM).

Said web-based data processing system also distributes Request for Quotations (RFQs) to Moderator in a B2B exchange, which can drastically speed up a RFQ process. Said RFQ distribution method requires at least 3 hubs, such as Asia-Pacific, Europe and NAFTA Hubs around the world to respectively entertain RFQs for a period of 8 hours or less than that. (Said three regions have a time difference of 8 hours one another with respect to GMT.)

Lastly, the web-based data processing system is able to directly communicate with a collaborative platform in a B2B exchange. Said collaborative platform may be integrated with existing web-based Enterprise Resource Planning (ERP) and Supply Chain Management (SCM).

### DETAIL EMBODIMENTS OF THE PRESENT INVENTION

Said web-based data processing system is able to upgrade a conventional B2B exchange to a total integrated electronic business for one-stop manufacturing solution.

Targeted one-stop manufacturing solutions covers the following:

a. Customisation involving the design and production of mechanical/electronic components of first article/prototype, from manufacturing, warehousing and distribution to end customers;

b. Trading of Industrial products which include machinery, equipments and its related tools and accessories:

c. Retrofittng of machinery and equipment,

d. Licensing of the design, numerical engineering, manufacturing and simulation softwares;

e. Value added production services;

f. Regional center for international procurement activities;

g. Financing, leasing and hire-purchase of the related production, machinery and equipment;

h. Insurance on the related production machinery and equipment;

i. Services in the advanced numerical engineering and simulation activities;

j. Regional center for research and testing center activities;

k. Remote software services, which include design, numerical engineering, manufacturing and simulation tool;

l. Web-based maintenance and support to process lines, systems and machine.

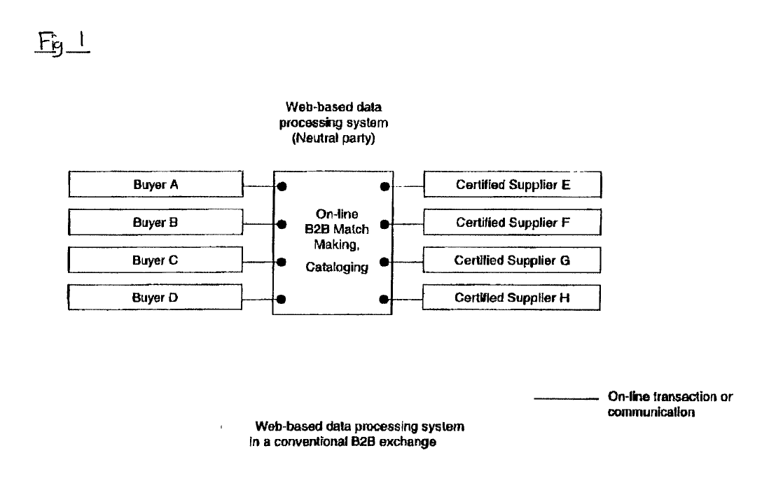

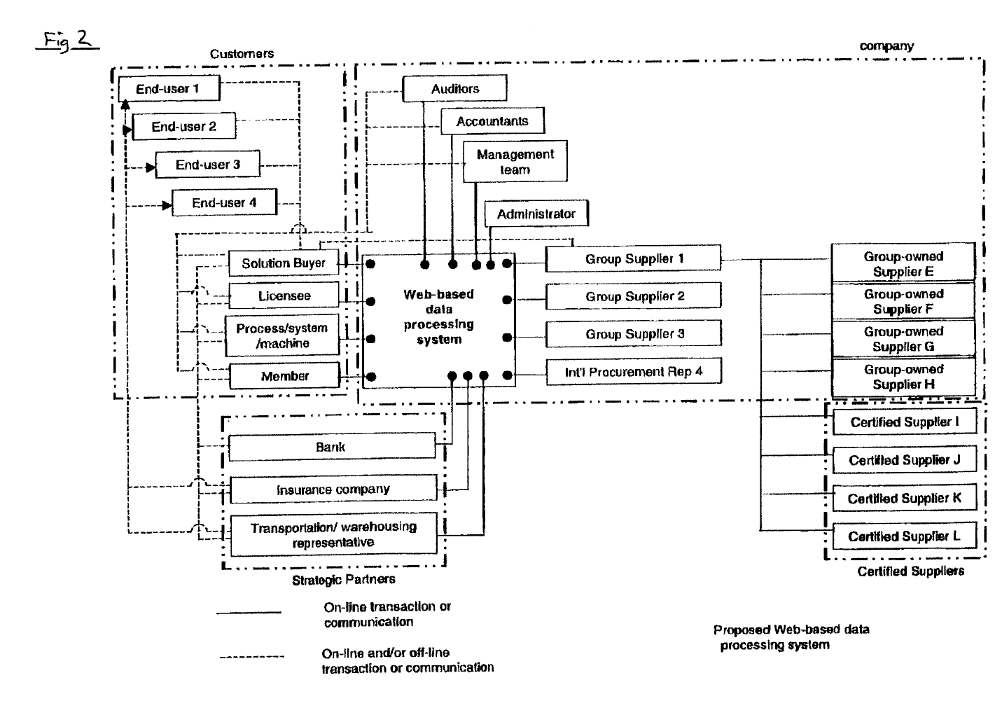

FIG. 2 shows the integration of proposed web-based data processing system with customers, suppliers, strategic partners and others.

Components that directly link to said system include management team/account/audit/administrator, customers, group suppliers and strategic partners. Likewise, group-owned suppliers and certified suppliers are indirectly linked to B2B exchange via their respective group suppliers in related sectors. (E.g. group-owned Diecasts supplier and Certified Diecasts supplier report to Diecasts Group Supplier).

All group-owned suppliers (except certified suppliers) belong to a consortium while certified suppliers are the affiliates to said consortium.

This B2B exchange only allows a group supplier from each sector in manufacturing field so that these group suppliers do not have conflicts of interest one another.

Management team, account, audit and administrator are independently linked to the web-based data processing system to monitor and run all business transactions.

A new supplier is invited to be a certified supplier it it can offer solution/product which cannot be provided by group-owned suppliers, This new supplier is required to undergo an assessment to obtain its certification.

Strategic partners in said B2B exchange consist of a bank, an insurance company and a transportation/warehousing representative.

1. Bank to provide financing, leasing and hire purchase;

2. Insurance company to compulsorily insure all business transactions;

3. Transportation/warehousing representative to provide freight forwarding, shipping and warehousing services.

Customers in said B2B exchange include solution buyers, end-users, licensees, “pay as you go” member, “flat fee” member, web-based process-lines, systems and machines. The term “solution buyers” in the context of present invention can be new/existing product initiators (Motorola, Hewlett Packard) or dealers (trading house) for the end-users. Hence, end-users shall not have direct links with the web-based data processing system.

All participants mentioned above, who have direct or indirect links to web-based data processing system, will be provided dedicated desktops for internet-speed communication, collaboration and commerce transaction.

All business transactions of said system are handled online with the following conditions:

(1) Management team/account/audit/administrator, group suppliers, group-owned suppliers and strategic partners are allowed to have on-line and off-line communications with said B2B exchange and customers.

(2) Certified suppliers are allowed to have on-line and off-line communications with said B2B exchange, but have NO off-line communication with customers. Their on-line communications with customers may only be possible if both parties' identities are encrypted and their communications are fully monitored by said B2B exchange.

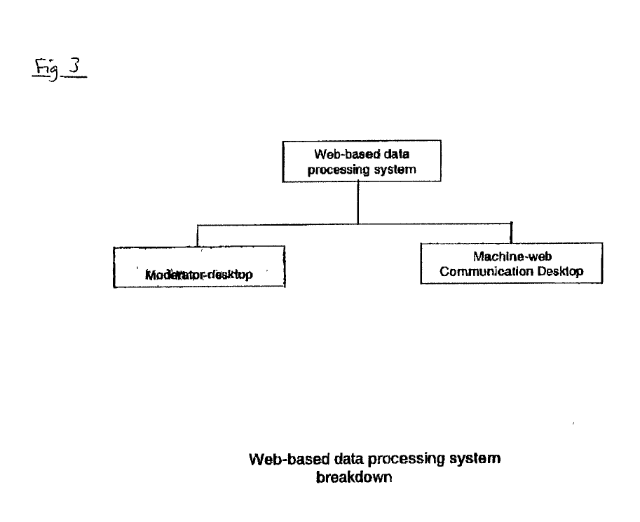

The web-based data processing system provides (1) a moderator desktop and (2) a machine web communication desktop. (refer to FIG. 3).

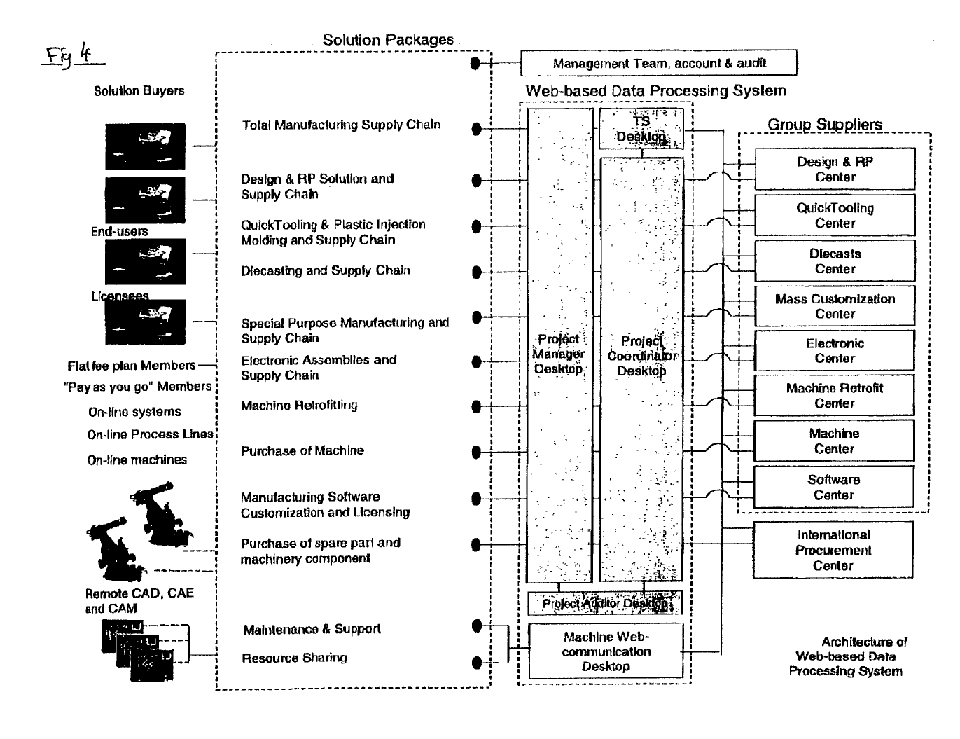

FIG. 4 illustrates the architecture of web-based data processing system in the present invention assists in business transaction between customers and group suppliers.

Said system offers a comprehensive solution packages to serve all kind of customer needs. Each solution package is directed to its respective group supplier. Solution packages for solution buyer or end-user include

a. Total manufacturing supply chain from Turnkey Center;

b. Industrial design & rapid prototyping (RP) and supply chain from Design & RP center,

c. Quick Tooling & Plastic Injection Moulding (PIM) and supply chain from QuickTooling Center,

d. Diecasting and supply chain from Diecasts Center;

e. Special purpose manufacturing and supply chain from Mass Customization Center;

f. Electronic assemblies and supply chain from Electronic Center;

g. Purchase of machine from Machine Center;

h. Machine retrofitting from Retrofit Center;

i. Purchase of Industrial spare part and machinery component from International Procurement Center;

Solution package of manufacturing software customization and licensing is offered to the licensees. This package is handled by Software Center.

Solution packages of maintenance & support are offered to the web-based systems, process lines and machines.

Solution package of resource sharing for “pay as you go” members and “flat fee” members, include

1. Experts: Center for advanced numerical engineering and simulation;

2. Hardware/Equipment; Research and testing center;

3. Software: Remote software services covering design, numerical engineering, manufacturing and simulation tool.

Both maintenance & support and resource sharing packages are managed by Machine-web Communication Desktop.

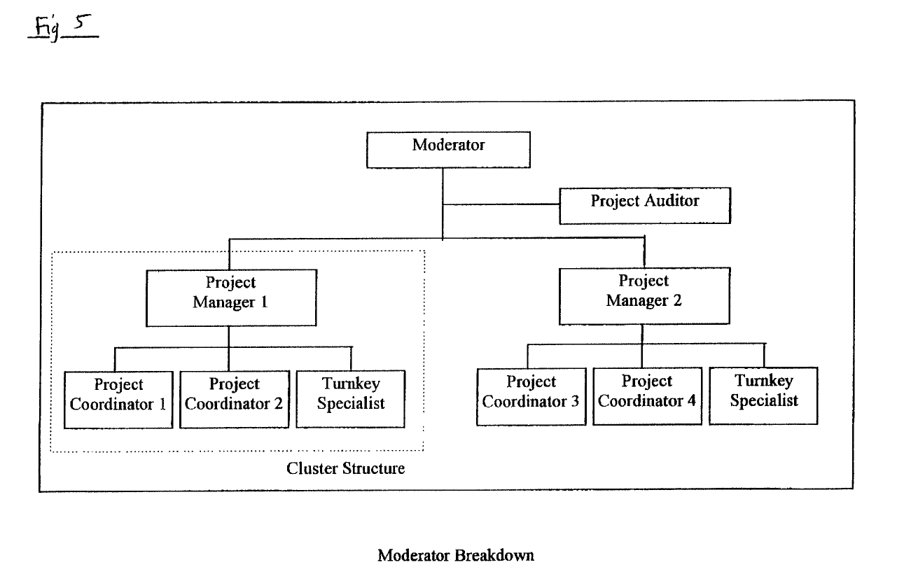

FIG. 5 shows the breakdown structure of Moderator Deskop. Generally, a cluster structure consists of a Project Manager (PM) Desktop, supported by a number of Project Coordinators' (PCs') desktops and Turnkey Specialists' (TSs') desktops. These are the desktops, which allows quick planning, quoting, coordination and supervisory on all business transactions. Such cluster structure can be duplicated/expanded tar Asia-Pacific Hub, Europe Hub and NAFTA Hub. Also, each hub may have more than one cluster dependent on its Request For Quotation (RFQ) capacity and number of projects.

Project Manager (PM) Desktop

Project Manager Desktop has the first communication/interaction with a new customer, who approaches said B2B exchange for a RFQ. In the present invention, PM Desktop has a set of tools on business and marketing aspect. Such desktop assists a project manager to understand and analyses customer needs/problems. Next, having inputs from project manager, PM desktop automatically proposes solutions, all manufacturing procedures, arranges with all facilities, bank and insurance company, as well as checks the availabilities at warehouses, freight-forwarding and shipping. Ultimately, with respect to customers' budget constraint, PM desktop shall calculate a total solution/production cost and the best delivery date.

To precisely quote on a RFQ PM desktop may raise request for sub-quotes for various small project scopes from the group suppliers through their dedicated desktops, or may refer and retrieve previous project records documented in the global database server.

Through Turnkey Specialist desktop or Project Coordinator Desktop, a project manager may activate Turnkey Specialists or Project Coordinators from the nearest region to meet a particular customer on-site if necessary.

Quoted RPQs will be handed/transferred over to Turnkey Specialists/Project Coordinators if said B2B exchange account division receives a purchase order (PO) from the customer.

Project Coordinator (PC) Desktop

PC Desktop receives projects from PM. Both parties may have an on-line discussion via their dedicated desktops. PC next plans the detail project schedule and budget according to PMs' proposal in his personal planner desktop. PC desktop will be alerted when the customer confirms the payment with the account division.

During the job execution, PC desktop

Allows project coordinator and other parties, such as PM, customer, auditor, supplier, etc. to communicate online;

Provides on-line tracking and control on the delivery schedule and pre-set expenditure, and to document related knowledge into central database,

On-line provides project status to customer,

On-line provides PM project status, reviews the status of expenditure and delivery schedule, receives instruction for project activation, and requests for consultation if necessary;

On-line checks and books all necessary transportations:

On-line checks and books all necessary warehousing facilities;

On-line orders material and equipment;

Turnkey Specialist (TS) Deskop

Basically, TS desktop has the similar function as PC desktop. The only difference is that TS desktop allows the execution of all manufacturing processes and procedures, set up of process line, system, etc, while PC desktop is specialized for a particular solution. Usually, a project will be handed-over/transferred to TS desktop when such project requires resources from more than one group supplier. (refer to FIG. 4)

Project Auditor (PA) Desktop

PA desktop allows an audit on PMs' RFQ progress, and TS/PCs' project statuses.

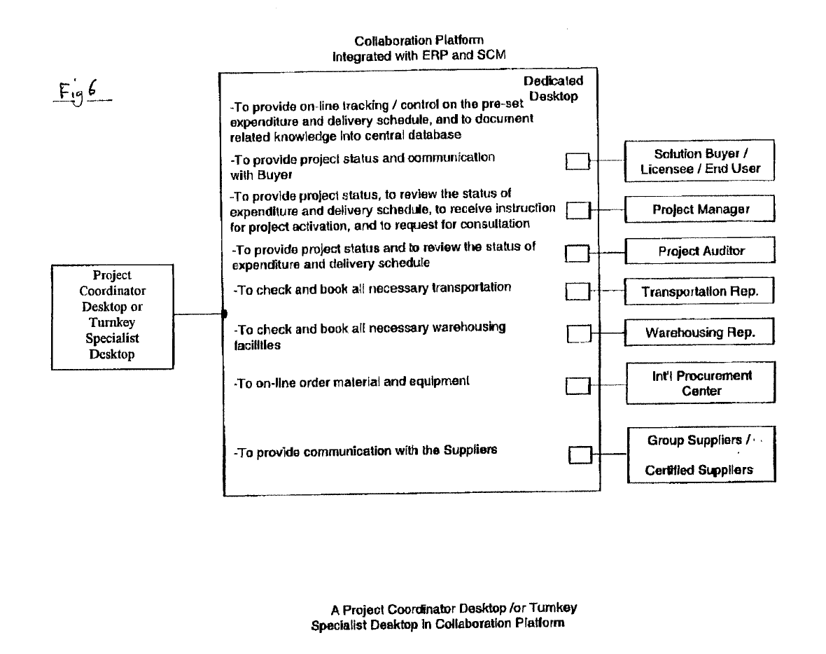

FIG. 6 describes the functions of PC or TS desktop in a collaborative platform. In the collaborative platform, all parties or members of the platform will be given a dedicated desktop. Each desktop is customized with respect to its own authority level. Dedicated Desktops in the present Invention are not limited to the following:

Personal planner desktop for PC and TS

Solution buyer desktop/End-user desktop/Licensee desktop

Project Manager Desktop

Project Auditor Desktop

Transportation Representative Desktop

Warehousing Representative Desktop

International Procurement Representative Desktop

Group supplier desktop/group-owned supplier desktop/certified supply desktop

Others: administrator desktop, account desktop, etc.

As illustrated in FIG. 6, each dedicated desktop is employed for its respective coordination and communication with PC or TS desktop.

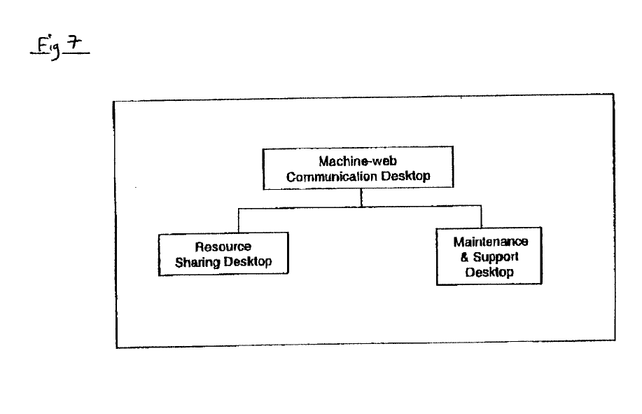

FIG. 7 shows a breakdown structure at Machine-web Communication Desktop. This desktop is generally divided into resource sharing and maintenance & support.

Resource Sharing

Said B2B exchange offers a compelling real-time on-line resource sharing service. This is to free companies from investing heavily in IT infrastructure, software & hardware systems and personnel/experts to reap new economy benefits.

Said real-time resource sharing service includes

A collaborative platform integrated with Enterprise Resource Planning (ERP) and Supply Chain Management (SCM).

Personnel/experts; Center for Advanced Numerical Engineering and Simulation, International Procurement Center, etc.

Hardware/Equipment: Research and Testing Center,

Software: Remote Computer-Aided Design (CAD), Remote Computer-aided Engineering (CAE) and Remote Computer-Aided Manufacturing (CAM)

Maintenance & Support

Said B2B exchange offers its manufacturing community a comprehensive service support, including:

Emergency support and critical service support; e.g. Emergency Shutdown system, Safety Control system, Fire & Gas systems for chemical application.

Routine technical support

Online Training/Seminar

Critical spare parts

Software and control upgrades (on-line and off-line)

Repair and test services

The web-based data processing system in the present invention directly communicate, retrieve and update related information or knowledge with a collaborative platform, integrated with existing web-based Enterprise Resource Planning (ERP) and Supply Chain Management (SCM).

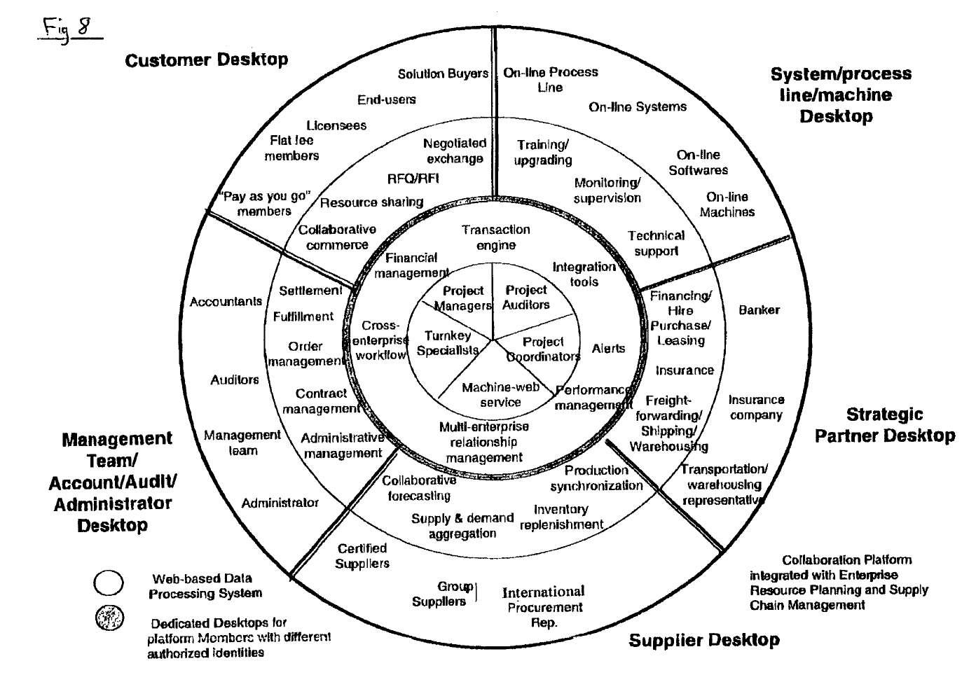

An overview of web-based data processing system architecture is shown in FIG. 8.

The web-based data processing system is situated at the “centroid” of the collaborative platform. Integrating existing web-based ERP and SCM technology/engine into the collaborative platform, this system architecture brings in all related members to support and access said system at their respectively authority levels. Each member is given a set of related tools (inner ring next to the member) to have direct and critical communication, collaboration and commerce transaction with said B2B exchange. Also, these members share a set of common management tools (outer ring next to B2B exchange) within the platform.

Members of this collaborative platform include Customers, Process lines/systems/machines, Strategic Partners, Suppliers and Management team/account/audit.

Generally, such collaboration environment reduces design-cycle time, minimize rework costs, enable innovation and product Improvement, and improve procurement efficiency. The present invention combines collaborative commerce solutions with direct commerce opportunities enabling businesses to efficiently and effectively design, market, configure and manufacture products at Internet speeds.

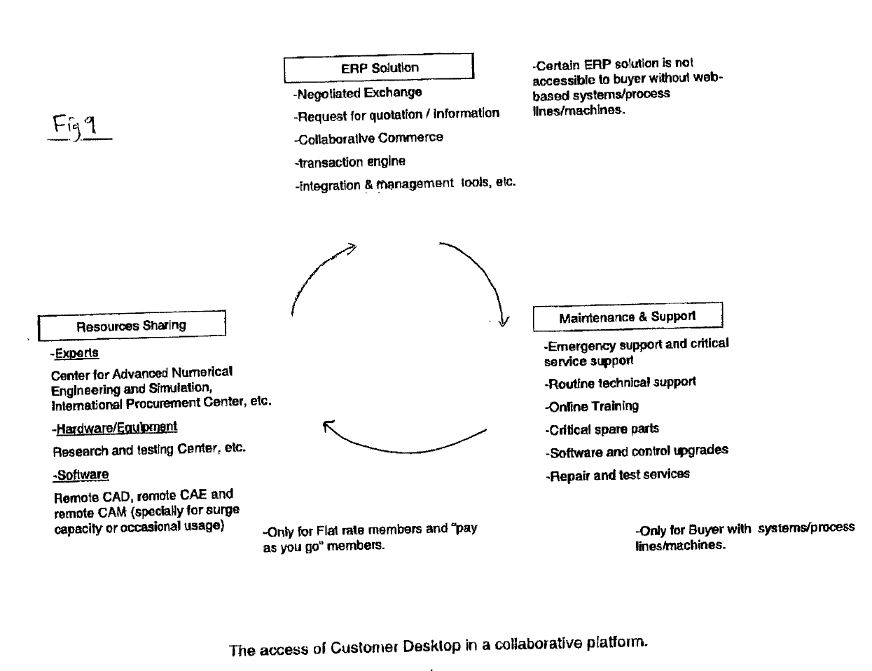

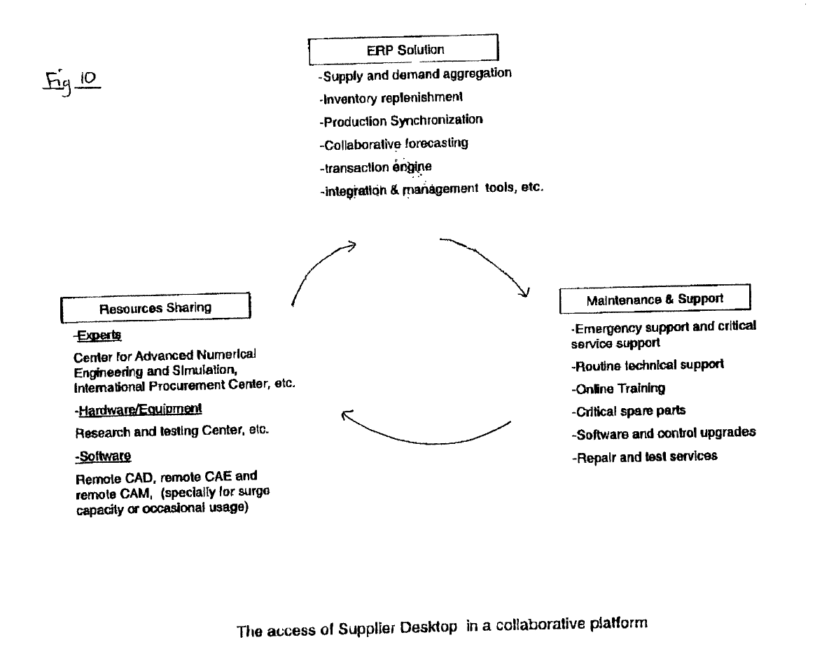

FIG. 9 and FIG. 10 respectively describe the authorities level of a customer desktop and supplier desktop in the collaborative platform, and the services and resources to which customer and supplier desktops may gain access will be apparent from these Figures.

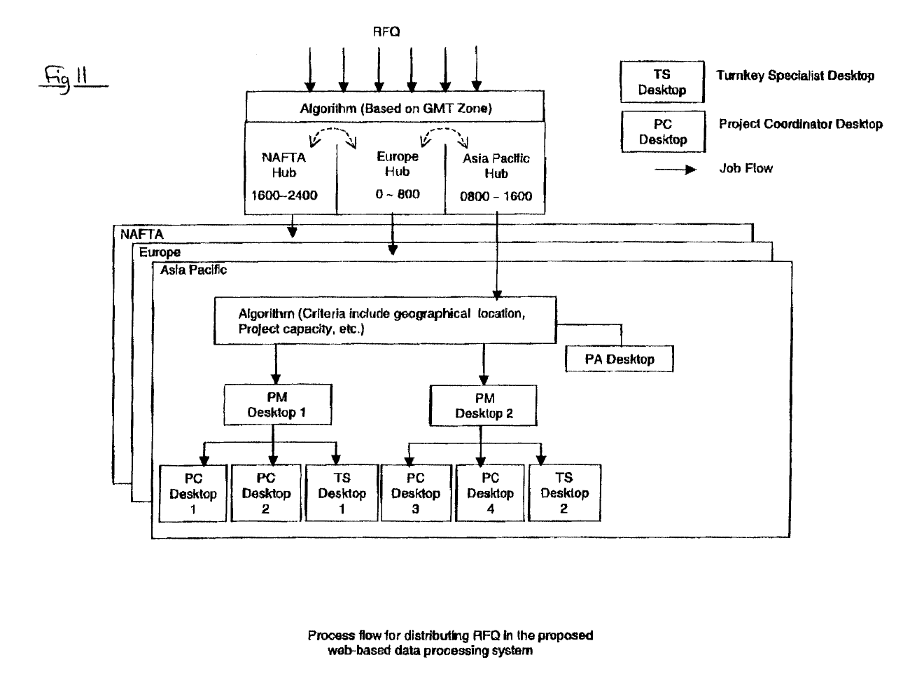

FIG. 11 shows the process flow for distributing RFQs In web-based data processing system.

(1) First, RFQs from all over the world will be uploaded into a dedicated RFQ server.

(2) The sending time of each RFQ is converted into GMT.

(3) These RFQs are then sorted among Asia-Pacific, Europe and NAFTA Hubs with respect to the hubs' GMT zone.

(4) RFQs in each hub may be further distributed among PMs with the respect to the geographical location, project capacity, etc.

(5) In case of server failure in a particular hub, special instruction/authority will be given by B2B exchange administrator to PMs in other hubs to specifically assist RFQs in the failure hub.

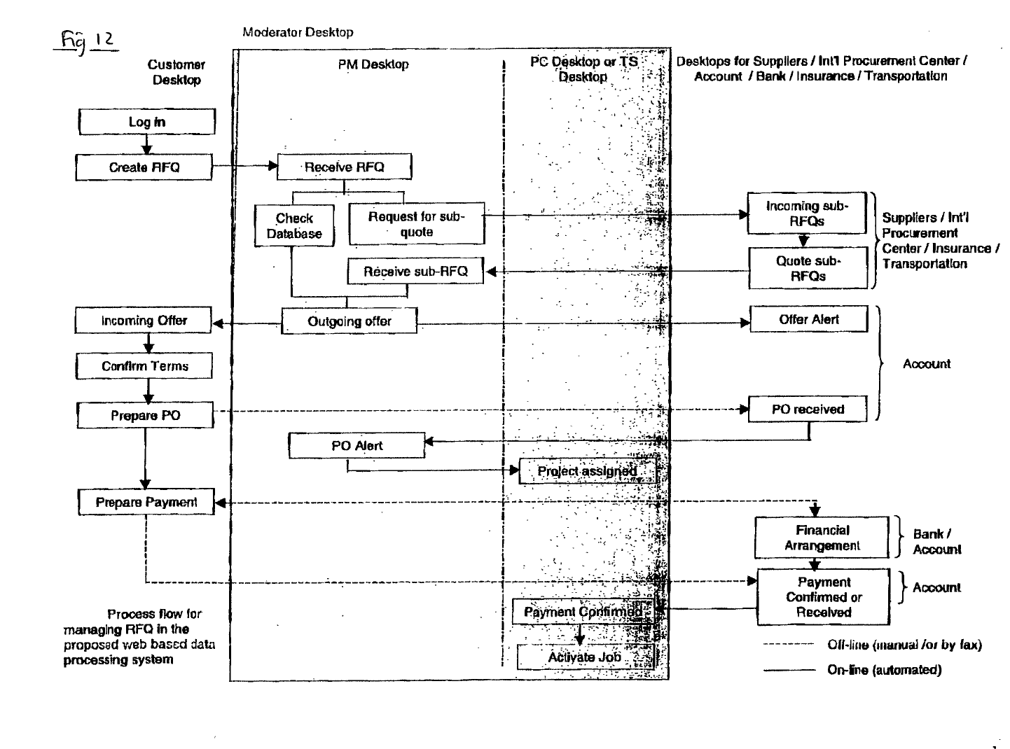

FIG. 12 illustrates a process flow for managing RFQs in web-based processing system. The sequence of steps involved in the processing of RFQ's will be readily appreciated from FIG. 12.

1. A data processing system for managing an exchange between an entity specifying a manufacturing task and a plurality of manufacturing facilities, the data processing system comprising:
first processing means for determining parameters of the manufacturing task;
second processing means for calculating an estimated cost of completing the manufacturing task and an estimated delivery schedule for a product of the manufacturing task on the basis of the parameters of the manufacturing task; and
third processing means for monitoring the progress of at least the specified manufacturing task.

2. A data processing system according to claim 1, comprising fourth processing means operable to monitor the capabilities and manufacturing schedules of at least some of the manufacturing facilities in real time.

3. A data processing system according to claim 1, comprising fifth processing means operable to provide on-line maintenance and support for the manufacturing task.

4. A data processing system according to claim 3, wherein the on-line maintenance and support include at least one of: emergency support; technical support; training; supply of spare parts; supply of software; and correction of software.

5. A data processing system according to claim 1, comprising sixth processing means operable to generate output relating to the progress of the manufacturing task.

6. A data processing system according to claim 1, further comprising storage means for storing information relating to each of the manufacturing facilities.

7. A data processing system according to claim 6, wherein the stored information relating to each of the manufacturing facilities includes past performance of the manufacturing facilities.

8. A data processing system according to claim 1, further comprising seventh processing means for receiving data specifying the manufacturing task from the entity and for analysing the data to determine the parameters of the manufacturing task.

9. A data processing system according to claim 1, wherein the parameters include at least one of: a material from which an item is to be made; the dimensions of the item; the function of the item; identification of a component to be included in the item, identification of tools required to produce the item; insurance requirements; warehousing requirements; identification of an existing machine with which the item must operate; details of software that must be created or customised for use with the item; identification of spare parts to be manufactured for use with the item; details of on-line maintenance and support required for the item; identification of software to be used in the production of the item; and which of the manufacturing facilities may be used in production of the item.

10. A data processing system according to claim 1, wherein the exchange is managed between the entity specifying a manufacturing task, the plurality of manufacturing facilities, and at least one of: a supplier of materials; a supplier of machinery; a licensor of software; a provider of software; a supplier of spare parts; a supplier of warehousing facilities; a supplier of transport services; a supplier of banking services; and a supplier of insurance services.

11. A data processing system according to claim 1, further comprising eighth processing means for allowing a further manufacturing facility to join the exchange.

12. A data processing system according to claim 1, further comprising ninth processing means for planning a set of manufacturing steps that are required to perform the manufacturing task.

13. A data processing system according to claim 1, further comprising tenth processing means for communicating with a selected supplier of materials and requesting the delivery of materials to a selected manufacturing facility.

14. A data processing system according to claim 1, further comprising eleventh processing means for providing computer-aided design facilities, computer-aided manufacturing facilities or computer-aided engineering facilities to the entity to allow the entity to further specify the manufacturing task.

15. A data processing system according to claim 1, wherein the data processing system is located on a server connected to a network.

16. A data processing system according to claim 15, wherein the data processing system communicates with the entity and with each of the manufacturing facilities over the network.

17. A data processing system according to claim 15, wherein the network is the Internet.

18. A data processing system according to claim 1, wherein the first, second and third processing means are the same processing means.

19. A system comprising a plurality of data processing systems according to claim 1, comprising means to allocate manufacturing tasks specified by entities associated with each of the data processing systems to manufacturing facilities associated with others of the data processing systems.

20. A system according to claim 19, wherein the allocation of manufacturing tasks among the manufacturing facilities associated with others of the data processing systems is based upon the geographical location of the manufacturing facilities.

21. A system according to claim 19, wherein the allocation of manufacturing tasks among the manufacturing facilities associated with others of the data processing systems is based upon parameters of the manufacturing task.

22. A method of managing an exchange between an entity specifying a manufacturing task and a plurality of manufacturing facilities, the method comprising the steps of:
determining parameters of the manufacturing task;
calculating an estimated cost of completing the manufacturing task and an estimated delivery schedule for a product of the manufacturing task on the basis of the parameters of the manufacturing task; and
monitoring the progress of at least the specified manufacturing task.

23. A method according to claim 22, comprising the step of monitoring the capabilities and schedules of at least some of the manufacturing facilities in real time.

24. A method according to claim 22, comprising the step of providing on-line maintenance and support for the manufacturing task.

25. A method according to claim 24, wherein the step of providing on-line maintenance and support comprises the step of providing at least one of: emergency support; technical support; training; supply of spare parts; supply of software; and correction of software.

26. A method according to claim 22, comprising the step of generating output relating to the progress of the manufacturing task.

27. A method according to claim 22, further comprising the step of storing information relating to each of the manufacturing facilities.

28. A method according to claim 27, wherein the step of storing information relating to each of the manufacturing facilities comprises the step of storing information relating to past performance of the manufacturing facilities.

29. A method according to claim 22, further comprising the steps of:
receiving data specifying the manufacturing task from the entity; and
analysing the data to determine the parameters of the manufacturing task.

30. A method according to claim 22, wherein the parameters include at least one of: a material from which an item is to be made; the dimensions of the item; the function of the item; identification of a component to be included in the item, identification of tools required to produce the item; insurance requirements; warehousing requirements; identification of an existing machine with which the item must operate; details of software that must be created or customised for use with the item; identification of spare parts to be manufactured for use with the item; details of on-line maintenance and support required for the item; identification of software to be used in the production of the item; and which of the manufacturing facilities may be used in production of the item.

31. A method according to claim 22, wherein the exchange is managed between the entity specifying a manufacturing task, the plurality of manufacturing facilities, and at least one of: a supplier of materials; a supplier of machinery; a licensor of software; a provider of software; a supplier of spare parts; a supplier of warehousing facilities; a supplier of transport services; a supplier of banking services; and a supplier of insurance services.

32. A method according to claim 22, further comprising the step of allowing a further manufacturing facility to join the exchange.

33. A method according to claim 22, further comprising the step of planning a set of manufacturing steps that are required to perform the manufacturing task.

34. A method according to claim 22, further comprising the step of communicating with a selected supplier of materials and requesting the delivery of materials to a selected manufacturing facility.

35. A method according to claim 22, further comprising the step of providing computer-aided design facilities, computer-aided manufacturing facilities or computer-aided engineering facilities to the entity to allow the entity to further specify the manufacturing task.

36. A method according to claim 22, wherein the method is implemented on a data processing system located on a server connected to a network.

37. A method according to claim 36, wherein the data processing system communicates with the entity and with each of the manufacturing facilities over the network.

38. A method according to claim 36, wherein the network is the Internet.

39. A method according to claim 22, wherein the steps of the method are carried out by a single processing means.

40. A method comprising the steps of:
managing a plurality of exchanges in accordance with the method of claim 22; and
allocating manufacturing tasks specified by entities associated with each of the exchanges to manufacturing facilities associated with others of the exchanges.

41. A method according to claim 40, wherein the allocation of manufacturing tasks among the manufacturing facilities associated with others of the exchanges is based upon the geographical location of the manufacturing facilities.

42. A method according to claim 40, wherein the allocation of manufacturing tasks among the manufacturing facilities associated with others of the exchanges is based upon parameters of the manufacturing task.
